(19) United States
(12) Patent Application Publication
(10) Pub. No.: US 2023/0057024 A1
(43) Pub. Date: Feb. 23, 2023

(54) METHOD FOR PRODUCING MINERAL WOOL

(71) Applicant: SAINT-GOBAIN ISOVER, COURBEVOIE (FR)

(72) Inventor: Andrea GIOIA, PARIS (FR)

(73) Assignee: SAINT-GOBAIN ISOVER, COURBEVOIE (FR)

(21) Appl. No.: 17/784,310

(22) PCT Filed: Dec. 9, 2020
(86) PCT No.: PCT/FR2020/052366

§ 371 Date: Jun. 10, 2022

(30) Foreign Application Priority Data
Dec. 11, 2019 (FR) FR1914152

(51) Int. Cl. C03C 13/06; C03C 3/087; C03C 1/00; C03B 37/04; C03B 5/02; C03B 5/235

(52) U.S. Cl. CPC C03C 13/06; C03C 3/087; C03C 1/002; C03B 37/04; C03B 5/02; C03B 5/2356; C03C 2213/00

(57) ABSTRACT

The present invention relates to a method for producing mineral wool having a chemical composition, expressed as a percentage by weight of oxides, comprising:

| | |
|---|---|
| SiO2 | 30-50% |
| Al2O3 | 15-35% |
| CaO | 5-25% |
| MgO | 1-25% |
| Fe2O3 | 2-15% |
| Na2O + K2O | >10% |

said method comprising providing a mixture of raw materials, melting said mixture of raw materials to obtain a molten material, and fiberizing the molten material; characterized in that the mixture of raw materials comprises at least 8.5% by weight of a recycled raw material comprising at least 3% of magnesium, expressed by weight of oxides, said recycled raw material being substantially free of carbonates, and in that the mixture of raw materials is free of dolomite and magnesia.

The present invention relates to the field of artificial mineral fibers. It more particularly targets a method for producing mineral wool, intended especially for producing thermal and/or acoustic insulation products.

Mineral wools are conventionally obtained by melting a mixture of raw materials in a melting furnace, the molten material thus obtained subsequently being decanted into a fiberizing device, by means of which the mineral wool is formed. The raw materials, generally natural, are selected, and the proportions thereof adapted, based on the desired target chemical composition for the mineral wool. Magnesium oxide may be part of the composition of mineral wools, with the aim of affording them certain properties, or of improving the processability of said mineral wools. Dolomite and magnesia are the main magnesium carriers used in the production of mineral wools. However, these raw materials have certain disadvantages. Indeed, they may cause phenomena of explosive fracturing or “decrepitation” during the melting of the mixture of raw materials. This leads to the formation of a layer formed of decrepitation debris and dust on the top of the furnace, which may be harmful both for the operation of the furnace and for the quality of the bath of molten material. Moreover, due to their chemical compositions, these raw materials make a significant contribution to the release of CO₂ during the melting of the mixture of raw materials.

The aim of the present invention is to overcome the aforementioned disadvantages by proposing an economical method for producing mineral wool comprising magnesium oxide, while ensuring good processability, the maintenance, indeed even improvement, of the quality of the molten bath and the properties of the mineral wool, especially from the perspective of resistance to high temperatures, and while reducing the environmental impact.

Thus, a first aspect of the present invention relates to a method for producing mineral wool having a chemical composition, expressed as a percentage by weight of oxides, comprising:

| | |
|---|---|
| SiO2 | 30-50% |
| Al2O3 | 15-35% |
| CaO | 5-25% |
| MgO | 1-25% |
| Fe2O3 | 2-15% |
| Na2O + K2O | >10% |

said method comprising:
providing a mixture of raw materials;
melting said mixture of raw materials to obtain a molten material;
fiberizing the molten material;
   characterized in that the mixture of raw materials comprises at least 8.5% by weight of a recycled raw material comprising at least 3.5% of magnesium, expressed by weight of oxides, said recycled raw material being substantially free of carbonates, and in that the mixture of raw materials is free of dolomite and magnesia.

The method according to the invention relates to the production of mineral wool, the chemical composition of which leads to a high liquidus temperature and a high fluidity at the fiberizing temperature, associated with a high glass transition temperature.

The silica (SiO₂) content is within a range extending from 30 to 50%, preferably from 35 to 48%, indeed even 37 to 45%.

The alumina (Al₂O₃) content is within a range extending from 15 to 35%, preferably from 18 to 30%, indeed even 20% to 28%.

The lime (CaO) content is within a range extending from 5 to 25%, preferably from 7 to 20%, indeed even 8% to 18%.

The magnesia (MgO) content is within a range extending from 1 to 25%, preferably from 1 to 15%, indeed even 1 to 10%.

The mineral wool generally does not comprise alkaline-earth metal oxides other than CaO and MgO. Nonetheless, it can contain small amounts of BaO or SrO, at contents which may range up to 2%, indeed even 1%, 0.20% or even 0.1%, these oxides being able to be present as impurities in certain raw materials.

The total content of alkali metal oxides (R₂O), in particular sodium oxide (Na₂O) and potassium oxide (K₂O), is greater than 10%, preferably from 10.2 to 20%, indeed even from 10.5 to 15%. The Na₂O content is typically within a range extending from 4 to 20%, preferably from 5 to 15%, indeed even 6 to 13%. The K₂O content, for its part, is typically at most 20%, preferably from 1 to 15%, indeed even 2 to 10. The mineral wool preferably does not comprise any alkali metal oxide other than Na₂O and K₂O. Nonetheless, it can contain small amounts of Li₂O, sometimes present as impurities in certain raw materials, at contents which may range up to 0.5%, indeed even 0.2%, or even 0.1%.

The iron oxide content (total iron expressed in the form of F₂O₃) is within a range extending from 2 to 15%, preferably from 2 to 12%, indeed even 2.5 to 10%.

The sum of the contents of SiO₂, Al₂O₃, CaO, MgO, R₂O and Fe₂O₃ preferably represents at least 95%, in particular at least 97%, indeed even at least 98% by weight of the composition of mineral fibers.

The chemical composition of the mineral wool can also contain P₂O₅, in particular at contents which can range up to 3%, indeed even up to 1.2%. However, it is preferably free of P₂O₅.

The composition of the mineral wool can also comprise other elements present in particular as unavoidable impurities. It can comprise titanium oxide (TiO₂) and zirconia (ZrO₂) at contents within a range extending up to 3%, in particular from 0.1 to 2.0%, indeed even 1.0%.

The chemical composition of the mineral wool typically comprises less than 0.1% by weight of halogen, in particular of fluorine.

It is obvious that the different preferred ranges described above can be freely combined with one another, it not being possible for all the different combinations to be listed for the sake of conciseness.

Due to its composition, the mineral wool may have the advantage of being both biosoluble, in other words having the ability to rapidly dissolve in physiological medium, with a view to preventing any potential pathogenic risk associated with the potential accumulation of extremely fine fibers in the body by inhalation, and of having good resistance to very high temperatures. The fire resistance of a structural element corresponds to the period of time during which the element retains its structural function, guarantees flame resistance, and retains its thermal insulation role. The standard fire test generally consists of a rise in temperature according to standard ISO 834, based on the curve of the temperatures of a cellulose fire.

Conventionally, the mineral wool composition as described above is obtained by preparing and melting a mixture of raw materials. The method according to the invention comprises a step of providing a mixture of raw materials comprising at least 8.5% by weight of a recycled raw material comprising at least 3.5%, preferably at least 4%, indeed even 5%, of magnesium, expressed by weight of oxides. The use of such a raw material makes it possible to dispense with dolomite and magnesia and enables a better melt quality. The other raw materials may be selected from the raw material conventionally used in the production of mineral wools, such as limestone, phonolite, nepheline syenite, feldspar, basalt, sodium carbonate, iron oxides. Their respective proportions in the mixture of raw materials are determined by the person skilled in the art based on their chemical compositions and on the target chemical composition of the mineral wool to be obtained. In particular, the mixture of raw materials preferably comprises at least 1%, more preferentially at least 2%, or even at least 3% by weight of bauxite as aluminum carrier.

The recycled raw material may be a by-product derived from the processing of aluminum dross (also referred to as salt slag, black dross, white dross or salt cake) originating from the production and/or recycling of aluminum metal. In aluminum production, first smelting dross which forms at the surface of the tanks contains a high percentage of aluminum metal. This dross is thus generally processed, for example in rotary furnaces, to recover the aluminum it contains. In particular, in some technologies, processing salts can be added during this second smelting. Second smelting dross, which contains low proportions of aluminum metal, can in turn be processed in order to extract the residual aluminum metal therefrom and to recycle the processing salts. Some by-products of this processing, consisting mainly of mixtures of oxides and substantially free of metal residues, can be used as recycled raw material in the method according to the invention. These by-products can in turn be subjected to certain processing (granulation, drying, calcination, etc.) before being used in the method according to the invention. Aside from reducing the amount of residual water and other volatile elements such as halogens and ammonia, calcination, for example in a rotary tube furnace, makes it possible to improve the particle size distribution. However, the recycled raw material is not limited to these examples.

The recycled raw material typically has a chemical composition, expressed by weight of oxides, comprising:

| | | |
|---|---|---|
| Al2O3 | 50 to 80%, | preferably 60 to 75%; |
| SiO2 | 2 to 25%, | preferably 5 to 50%; |
| MgO | 3 to 20%, | preferably 5 to 15%; |
| Fe2O3 | 0.5 to 10%, | preferably 1 to 8%. |

It typically comprises less than 0.9%, preferably less than 0.6%, by weight of halogen, in particular fluorine and chlorine. This is because the presence of halogens required expensive facilities for processing the fumes. In a particular embodiment, the recycled raw material is in particular free of fluorine, that is to say it comprises less than 0.1% by weight of fluorine.

The recycled raw material preferably has a composition such that the Al₂O₃/MgO weight ratio is greater than 8. Such a ratio is particularly advantageous for obtaining the mineral wool according to the invention without requiring the addition of dolomite.

The recycled raw material is preferably free of metal particles, in particular of aluminum metal. Small amounts of aluminum metal (typically up to 2%, preferably up to 1%, preferentially up to 0.5% by weight) may nonetheless be present, in particular when the recycled raw material is a by-product of aluminum dross processing. Similarly, small amounts of aluminum nitride (typically up to 3%, preferably up to 2%, preferentially up to 1% by weight) may also be present, in particular when the recycled raw material is a by-product of aluminum dross processing.

From a mineralogical perspective, the raw material is substantially free of carbonates, that is to say that it comprises at most 5%, preferably at most 2%, more preferentially at most 1%, indeed even at most 0.5% by weight of carbonates. It preferably comprises at least 20%, indeed even at least 30%, and generally up to 80%, indeed even up to 60%, by weight of amorphous phase. Significant proportions of amorphous phase promote melting. It may comprise at least 10%, indeed even at least 20%, and generally up to 50%, by weight of spinel-type crystalline phase comprising magnesium (Mg₁₋ₓMₓAl_{2-y}M′_{y}O₄ M and M′ being transition metals).

The mixture of raw materials is typically in pulverulent form. In particular, the mixture of raw materials preferably does not comprise briquettes.

The melting step can be carried out in different known ways, in particular by melting in a fuel-fired furnace or by electric melting. It is generally not carried out in a furnace of cupola type. The compositions of mineral fibers targeted by the present invention are not particularly compatible with this mode of melting, in particular because of the relatively high contents of alkali metals. Indeed, the mixtures of materials required to achieve these compositions tend to pass rapidly from the solid state to a low-viscosity liquid which can cover the coke particles and prevent combustion. Cupola-type furnaces also promote the evaporation of the alkali metals, generating not only losses of material but also environmental or safety problems due to the high reactivity of said alkali metals with other substances given off, such as sulfur.

The fuel-fired furnace comprises at least one burner, aerial (the flames are positioned above the bath of molten material and heat it by radiation) or immersed (the flames are created directly within the bath of molten material). The or each burner can be supplied with various fuels, such as natural gas or fuel oil.

“Electric melting” is understood to mean that the vitrifiable mixture is melted by the Joule effect, by means of electrodes immersed in the bath of molten material, with the exclusion of any use of other heating means, such as flames. The vitrifiable mixture is normally distributed homogeneously over the surface of the bath of molten material using a mechanical device and thus constitutes a heat shield which limits the temperature above the bath of molten material, with the result that the presence of a superstructure is not always necessary. The electrodes can be suspended so as to dip into the bath of molten material via the top, be installed in the bottom or also be installed in the sidewalls of the tank. The first two options are generally preferred for large-sized tanks, in order to achieve the best possible distribution of the heating of the bath of molten material. The electrodes are preferably made of molybdenum, indeed even optionally of tin oxide. The molybdenum electrode is preferably passed through the bottom via a water-cooled electrode holder made of steel.

The melting step can also employ both fuel-fired melting and electric melting, for example by employing a fuel-fired furnace also provided with electrodes in sidewalls, used to accelerate the melting of the vitrifiable mixture.

Conventionally, the type of mineral wool targeted by the method according to the invention is fiberized by centrifugation methods referred to as “external”, for example those of the type using a cascade of centrifugation wheels supplied with molten material by a static distribution device, as described in particular in patents EP 0465310 or EP 0439385. However, the mineral wool composition described above also enables fiberizing by centrifugation referred to as “internal”, that is to say which utilizes centrifuges rotating at high speed and with holes pierced in them, significantly reducing the amount of unfiberized material. This method is described in particular in patents EP 0189354 or EP 0519797. The fiberizing step is thus preferably carried out by internal centrifugation.

The present invention also relates to the use of a recycled raw material, or of a mixture of raw materials comprising comprises at least 8.5% by weight thereof, for the production of mineral wool having a chemical composition, expressed as percentage by weight of oxides, comprising:

| | |
|---|---|
| SiO2 | 30-50% |
| Al2O3 | 15-35% |
| CaO | 5-25% |
| MgO | 1-25% |
| Fe2O3 | 2-15% |
| Na2O + K2O | >10% |

characterized in that the recycled raw material comprises at least 3.5% of magnesium, expressed by weight of oxides, and is substantially free of carbonates. The mixture of raw materials is moreover preferably free of dolomite and of magnesia. The use of the recycled raw material as described above, and more generally of a mixture of raw materials comprising same, makes it possible to significantly reduce carbon dioxide emissions originating from the melting of the raw materials.

Another subject matter of the present invention is a mineral wool capable of being obtained by the above-described method. Such a mineral wool comprises at least 8.5% by weight of a recycled raw material comprising at least 3% of magnesium, expressed by weight of oxides, said recycled raw material being substantially free of carbonates, and has a chemical composition, expressed as percentage by weight of oxides, comprising:

| | |
|---|---|
| SiO2 | 30-50% |
| Al2O3 | 15-35% |
| CaO | 5-25% |
| MgO | 1-25% |
| Fe2O3 | 2-15% |
| Na2O + K2O | >10%. |

Another subject matter of the invention is a thermal insulation product comprising a mineral wool as described above. Such a product is provided in particular in the form of rolls or panels. It can be employed, for example, in buildings, in industry or in means of transportation, in particular rail or shipping. It is particularly suitable for applications in which it may be subjected to high temperatures, either continuously (insulation of domestic or industrial ovens or stoves, or of pipes for the transportation of fluids) or exceptionally, in a fire-protection role (fire doors, insulation of boats, tunnels or offshore platforms, etc.). More generally, the product according to the invention can be employed to thermally insulate any type of buildings, tertiary sector buildings or living quarters (multi-unit or individual). It can, for example, be used in systems for insulating via the outside, for the insulation of wooden-framed houses, in sandwich panels, in ventilation ducts, etc.

The features described above in relation to the method according to the invention, in particular regarding the mineral wool composition, the mixture of raw materials and the recycled raw material, also apply to the other aspects of the invention (use of the recycled raw material or of the mixture of raw materials comprising same, the mineral wool or the insulation product), despite these not being repeated for the sake of conciseness.

The following examples nonlimitingly illustrate the invention.

### EXAMPLES

Productions of mineral wool having a target chemical composition as presented in table 1 were carried out starting from different mixtures of materials. The mixture of raw materials of comparative example C1 is a conventional mixture comprising dolomite as magnesium carrier. In example l1 according to the invention, the dolomite was entirely substituted by a recycled material according to the invention. The compositions of the mixtures of raw materials are detailed in table 2. Table 3 presents the chemical composition of the recycled material.

TABLE 1

| | SiO₂ | Al₂O₃ | CaO | MgO | Fe₂O₃ | Na₂O | K₂O | TiO₂ | Other |
|---|---|---|---|---|---|---|---|---|---|
| % by | 42.7 | 22.9 | 14.4 | 1.7 | 5.6 | 6.7 | 4.0 | 1.0 | 1.0 |
| weight | | | | | | | | | |

TABLE 2

| Composition of the mixture | | |
|---|---|---|
| of raw materials (kg) | C1 | I1 |
| Dolomite | 63 | — |
| Recycled raw material | — | 100 |
| Bauxite | 135.4 | 45 |
| Limestone | 209 | 238.4 |
| Phonolite | 606 | 606 |
| Nepheline syenite | 65 | 65 |
| Iron oxide | 37.5 | 34.7 |
| Sodium carbonate | 36 | 33 |

TABLE 3

| | SiO₂ | Al₂O₃ | CaO | MgO | Fe₂O₃ | Na₂O | Cl | F | Other |
|---|---|---|---|---|---|---|---|---|---|
| % by | 11.3 | 68.8 | 3.2 | 7.5 | 4 | 1.7 | 0.05 | 0 | 3.4 |
| weight | | | | | | | | | |

During the various production runs, no decrepitation was observed during the melting of the mixtures of raw materials of example I1. This results in a significant reduction in the amount of substances given off and the risk of obstructing the regenerators, compared to the use of a mixture of raw materials of example C1. The stability of the composition of the molten bath is also improved compared to example C1. Finally, a reduction of 2 to 5% in the CO2 emissions during the melting of the mixtures of raw materials of example I1 was observed compared to that of example C1.

1. A method for producing mineral wool having a chemical composition, expressed as a percentage by weight of oxides, comprising:

| | |
|---|---|
| [[SiO2]] SiO₂ | 30-50%; |
| Al₂O₃ | 15-35%; |
| CaO | 5-25%; |
| MgO | 1-25%; |
| Fe₂O₃ | 2-15%; and |
| Na₂O + K₂O | >10%, |

said method comprising:
melting a mixture of raw materials to obtain a molten material; and
fiberizing the molten material;
wherein the mixture of raw materials is in pulverulent form and comprises at least 8.5% by weight of a recycled raw material comprising at least 3% of magnesium, expressed by weight of oxides, said recycled raw material being substantially free of carbonates, and wherein mixture of raw materials is free of dolomite and magnesia.

2. The method according to claim 1, wherein the chemical composition of the mineral wool comprises less than 0.1% by weight of halogen.

3. The method according to claim 1, wherein the recycled raw material comprises less than 0.9% by weight of halogen.

4. The method according to claim 1, wherein the recycled raw material is free of fluorine.

5. The method according to claim 1, wherein the recycled raw material comprises up to 2% by weight of aluminum metal.

6. The method according to claim 1, wherein the recycled raw material has a chemical composition, expressed by weight of oxides, comprising:

| | |
|---|---|
| Al₂O₃ | 50 to 80%; |
| [[SiO2]] SiO₂ | 2 to 25%; |
| MgO | 3 to 20%; |
| Fe₂O₃ | 0.5 to 10%. |

7. The method according to claim 1, wherein the recycled raw material has a chemical composition, expressed by weight of oxides, in which a weight ratio of Al₂O₃/MgO is greater than 8.

8. The method according to claim 1, wherein the mixture of raw materials does not comprise briquettes.

9. The method according to claim 1, wherein the mixture of raw materials comprises at least 1% by weight of bauxite.

10. The method according to claim 1, wherein the mixture of raw materials is melted in a fuel-fired furnace and/or by electric melting.

11. The method according to claim 1, wherein the fiberizing is carried out by internal centrifugation.

12. The method according to claim 1, wherein the recycled raw material comprises less than 0.6% by weight of halogen.

13. The method according to claim 1, wherein the mixture of raw materials is melted in a submerged combustion furnace.
